(19) United States
(12) Patent Application Publication
(10) Pub. No.: US 2019/0135015 A1
(43) Pub. Date: May 9, 2019

(54) Page Turning Assembly

(71) Applicant: Russ Rhea, Eminence, IN (US)

(72) Inventor: Russ Rhea, Eminence, IN (US)

(21) Appl. No.: 15/806,415

(22) Filed: Nov. 8, 2017

(51) Int. Cl. B42D 9/04

(52) U.S. Cl. CPC B42D 9/04

(57) ABSTRACT

A page turning assembly for turning a page includes a grip that has a first end and a second end. The grip is elongated from the first end to the second end and has a length from the first end to the second end between 1.5 inches and 7.0 inches. A tip is mounted to the first end of the grip and has distal end with respect to the grip. A perimeter wall extends away from the distal end and toward the grip. The tip comprises of a friction enhancing material that frictionally engages paper.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98.

The disclosure and prior art relates to page gripping devices and more particularly pertains to a new page gripping device for turning a page.

### BRIEF SUMMARY OF THE INVENTION

An embodiment of the disclosure meets the needs presented above by generally comprising a grip that has a first end and a second end. The grip is elongated from the first end to the second end and has length from the first end to the second end that is between 1.5 inches and 7.0 inches. A tip is mounted to the first end of the grip and has a distal end with respect to the grip. A perimeter wall extends away from the distal end and toward the grip. The tip comprises of a friction enhancing material configured to frictionally engage paper.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a page turning assembly according to an embodiment of the disclosure.

FIG. 2 is a front view of an embodiment of the disclosure.

FIG. 3 is a side view of an embodiment of the disclosure.

FIG. 4 is a front view of an embodiment of the disclosure.

### DETAILED DESCRIPTION OF THE INVENTION

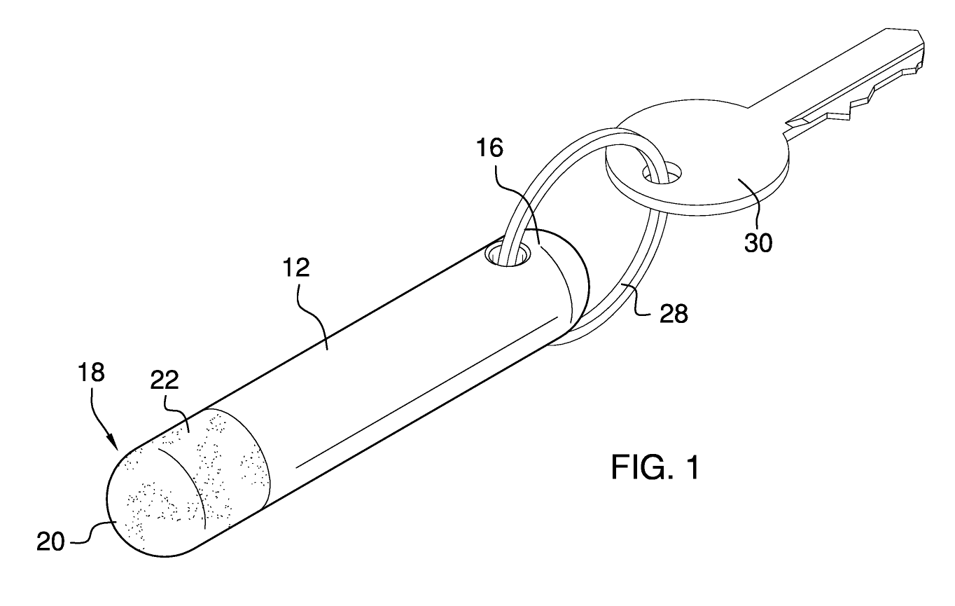

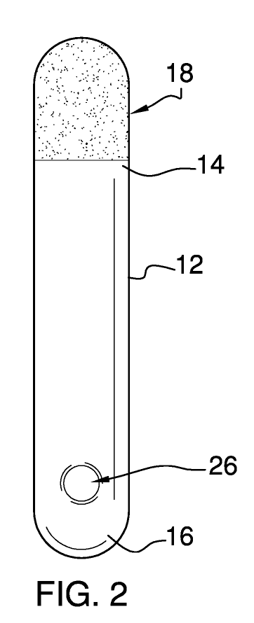

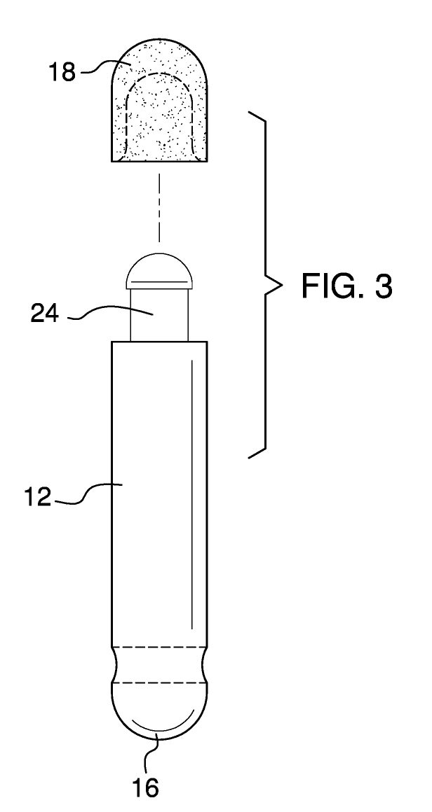

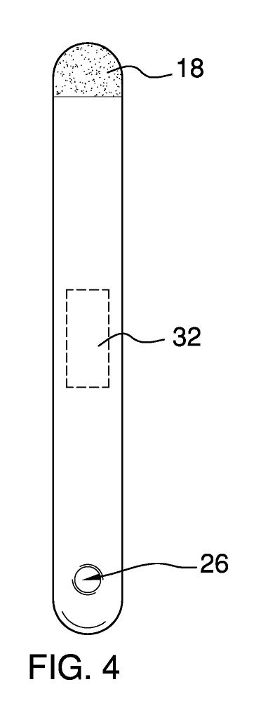

With reference now to the drawings, and in particular to FIGS. 1 through 5 thereof, a new page gripping device embodying the principles and concepts of an embodiment of the disclosure and generally designated by the reference numeral 10 will be described.

As best illustrated in FIGS. 1 through 5, the page turning assembly 10 generally comprises a grip 12 that has a first end 14 and a second end 16. The grip 12 is elongated from the first end 14 to the second end 16 and has a cylindrical shape. The grip 12 has a length from the first end 14 to the second end 16 between 1.5 inches and 7.0 inches and a diameter between 0.25 inches and 0.60 inches. The second end of the grip may have a hemi-spherical shape.

A tip 18 is mounted to the first end 14 of the grip 12 and has a distal end 20 with respect to the grip 12. A perimeter wall 22 extends away from the distal end 20 and toward the grip 12. The distal end 20 is planar and the perimeter wall 22 has a convexly arcuate shape. The tip 18 comprises a friction enhancing material that frictionally engages paper. The friction enhancing material is resiliently compressible and may comprise a polyurethane material or any other material suitable to frictionally engage paper.

A rod 24 is attached to the tip 18 opposite the distal end 20. The rod 24 extends into the first end 14 of the grip 12 and couples the tip 18 to the grip 12. The rod 24 is extendable outwardly of the grip 12 to increase a distance between the tip 18 and the second end 16. The rod 24 is completely removable from the grip 12.

The grip 12 has an aperture 26 that extends therethrough and is positioned adjacent to the second end 16. A key ring 28 may extend through the aperture 26 to couple the grip to keys 30. A magnet 32 is attached to the grip 12 and may attach the grip 12 to a magnetically attractive material.

In use, a person holds the grip 12 of the assembly with the tip 18 facing toward a paper page. The person then places the tip 18 on the page and strokes the tip 18 across the page such that the tip 18 frictionally engages and moves the page as the tip 18 is stroked to flip the page across a binding.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A page gripping assembly used to frictionally engage a paper page to facilitate turning of the page, said page gripping assembly comprising:
a grip having a first end and a second end, said grip being elongated from said first end to said second end, said grip having a length from said first end to said second end being between 1.5 inches and 7.0 inches;
a tip being mounted to said first end of said grip, said tip having a distal end with respect to said grip, a perimeter wall extending away from said distal end and toward said grip, said tip comprising a friction enhancing material configured to frictionally engage paper; and
a rod extending from said grip, said rod having a bulbous portion spaced from said grip, said bulbous portion being insertable into said tip wherein said tip is frictionally attached to said rod, said rod extending into said first end of said grip and coupling said tip to said grip, said rod being extendable outwardly of said grip to increase a distance between said tip and said second end, said rod being completely removable from said grip.

2. The page gripping assembly according to claim 1, wherein said grip has a cylindrical shape, said grip having a diameter between 0.25 inches and 0.60 inches.

3. (canceled)

4. The page gripping assembly according to claim 1, wherein said friction enhancing material is resiliently compressible and comprising a polyurethane material.

5. (canceled)

6. (canceled)

7. The page gripping assembly according to claim 1, further including said grip having an aperture extending therethrough and positioned adjacent to said second end, a key ring extending through said aperture and being configured to be coupled to keys.

8. The page gripping assembly according to claim 1, further including a magnet being attached to said grip and being configured to attach said grip to a magnetically attractive material.

9. A page gripping assembly used to frictionally engage a paper page to facilitate turning of the page, said page gripping assembly comprising:
a grip having a first end and a second end, said grip being elongated from said first end to said second end, said grip having a cylindrical shape, said grip having a length from said first end to said second end being between 1.5 inches and 7.0 inches, said grip having a diameter between 0.25 inches and 0.60 inches, said second end having a hemi-spherical shape;
a tip being mounted to said first end of said grip, said tip having a distal end with respect to said grip, a perimeter wall extending away from said distal end and toward said grip, said tip comprising a friction enhancing material configured to frictionally engage paper, said friction enhancing material being resiliently compressible and comprising a polyurethane material;
a rod extending from said grip, said rod having a bulbous portion spaced from said grip, said bulbous portion being insertable into said tip wherein said tip is frictionally attached to said rod, said rod being extendable outwardly of said grip to increase a distance between said tip and said second end, said rod being completely removable from said grip;
said grip having an aperture extending therethrough and positioned adjacent to said second end, a key ring extending through said aperture and being configured to be coupled to keys; and
a magnet being attached to said grip and being configured to attach said grip to a magnetically attractive material.
